(19) United States
(12) Patent Application Publication
(10) Pub. No.: US 2006/0002595 A1
(43) Pub. Date: Jan. 5, 2006

(54) Print image synthesizing device and method, and print image synthesizing program

(75) Inventors: Masanori Hara, Tokyo (JP); Hiroaki Toyama, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Corporation, Tokyo (JP)

(21) Appl. No.: 11/171,455

(22) Filed: Jul. 1, 2005

(30) Foreign Application Priority Data
Jul. 5, 2004 (JP) 197920/2004

(51) Int. Cl. G06K 9/00; G06K 9/32

(52) U.S. Cl. 382/124; 382/294

(57) ABSTRACT

A print image synthesizing device compensates for distortion of at least one of a first print impression of an object and a second print impression of the same object to approximate the first print impression and the second print impression with each other. Portions of the first print impression and the second print impression are selected to generate one synthesized print image of the object.

### BACKGROUND OF THE INVENTION

1. Field of the Invention

The present invention relates to a print image synthesizing device and method or the like employed in print matching including any of fingerprint, palm print and footprint etc. matching.

2. Description of the Related Art

In general, fingerprints, which are each constituted of a large number of ridges in a streaked pattern, have two primary features of uniqueness and permanence of the fingerprints. Therefore, they have been utilized for a long time as means for confirming identity. There are two types of fingerprint impressions used for criminal investigations as inked fingerprints. They are a rolled impression of a fingerprint, and a flat impression of a fingerprint.

The rolled impression includes lateral portions of a finger and is effective in matching of a latent print which also includes finger's lateral portions. However, the rolled impression has its drawbacks. They are (1) a top portion of fingerprint called a fingertip is apt to be lacking, (2) the quality of an image is apt to become unclear due to a shift in rolling and fading and (3). image distortion due to rolling is apt to occur noticeably.

On the other hand, the flat impression has its advantages that although lateral portions are not inked, a fingertip is apt to be taken, distortion is less and the quality of an image is better.

The rolled impression has heretofore been principally used for the criminal investigations. This is because the rolled impression including lateral portions is advantageous over the flat impression for matching of a latent that is usually a small part or fragment.

Meanwhile, “Method and apparatus for matching streaked pattern image” related to a fingerprint matching have been disclosed in a patent document 1 (Japanese Unexamined Patent Publication No. 2004-78433). This document discloses that skeleton data or the like on the search sides and file sides are read and the reference data called base paired minutiae (BPM), which are used to determine order of processing sequence of target images, are determined.

Subsequently, the skeleton data on the file side are modified in accordance with the order defined based on the BPM. Thereafter, skeletons contained in the skeleton data on the search side are selected one by one, and each point on that selected skeleton is associated with one another with the paired point on the skeletons on the file side. The skeleton points associated with one another on the search side and file side are called “skeleton-overlapping points”. After their association, the length of the continuous skeleton-overlapping points is measured for each skeleton on the search side, and a score indicative of the degree of correspondence of the skeletons is calculated based on the length. Thus, the accuracy of fingerprint matching or the like is improved.

“Method and apparatus for analyzing streaked pattern image” related to a fingerprint matching have been disclosed in a patent document 2 (Japanese Unexamined Patent Publication No. 2004-78434). This document discloses that a minutia data matching unit creates information about paired minutiae. A skeleton data matching unit creates information about skeleton-overlapping points of the skeleton on the search side and file side. An image distortion compensating unit modifies data on the file side, using not only the paired minutia but also the information about the skeleton-overlapping points to thereby reduce distortion of an image. A fingerprint chart edit/display unit outputs both data on the search side and the modified data on the file side in such a manner that verification becomes easy to perform. For example, the fingerprint chart edit/display unit outputs the data on the search side and the modified data on the file side in overlapped form. Thus, a burden at the verification of a streaked pattern image of a fingerprint or the like is reduced and the accuracy of verification is improved.

Although the rolled impression has been primarily used for the criminal investigations as described above, it is desired that the flat impression is also used for latent matching because it has the advantages that the fingertip is inked and the image quality is good. When, however, the rolled impression and the flat impression are independently matched, the matching does not succeed when overlapping portions between the latent print and the rolled impression and, the latent print and the flat impression are small. FIGS. 13(D) and 13(E) show the examples.

FIG. 13(D) shows the manner in which a portion common to a transversely long rectangular rolled impression expressed in horizontal lines and a latent expressed in oblique lines overlap each other. The latent is fragmentary and also small in area. Assuming that the matching fails when an overlapping area is less than 60% of the area of the latent, the matching in FIG. 13(D) will fail because the common area is less than 50% of the area of the latent.

FIG. 13(E) shows the manner in which a portion common to a flat impression expressed in vertical lines and a latent expressed in oblique lines overlap each other. The latent is fragmentary and also small in area. Assuming the same as in FIG. 13(D), the matching in FIG. 13(E) will also fail because the common area is less than 50% of the area of the latent.

### SUMMARY OF THE INVENTION

Therefore, in view of the foregoing and other exemplary problems, drawbacks, and disadvantages, an exemplary feature of the present invention is to provide a print image synthesizing device and method or the like which relates a high-accuracy matching using first and second impressions (e.g., both a rolled impression and a flat impression in a non-limiting embodiment).

Herein below, exemplary case of fingerprint matching is described but of course the invention is not limited thereto and would be equally applicable to palm print, footprint etc. matching using two different ways of taking an impression.

In FIG. 13(F) in the meanwhile, a portion common to an image obtained by synthesizing a rolled impression expressed in horizontal lines and a flat impression expressed in vertical lines, and a latent expressed in oblique lines is as wide as about 70% of the area of the fragmentary latent. Therefore, its matching is expected to succeed.

Thus, even though individual images fail to succeed in matching, the matching can be expected to succeed by an image synthesis. However, even if the rolled impression and the flat impression are aligned by simple rotating and parallel shifting to form a synthesized image thereof, it results in a distorted fingerprint image and hence it is not worthwhile using it. The fingerprint image is distorted because all ridges cannot be connected smoothly. Therefore, the present invention solves this exemplary problem as explained below.

That is, an exemplary fingerprint image synthesizing device according to the present invention includes an image distortion compensating unit for compensating for distortion of at least one of a fingerprint rolled impression and a fingerprint flat impression to thereby approximate image data of the fingerprint rolled impression and the fingerprint flat impression to each other, and image synthesizing unit for selecting, cutting and pasting the fingerprint rolled impression and the fingerprint flat impression, which have been approximated by the image distortion compensating unit to generate one synthesized fingerprint image. By compensating for distortion of the fingerprint rolled impression and the fingerprint flat impression to approximate these image data to each other, the ridges of the synthesized fingerprint image, obtained by cutting and pasting these image data, are smoothly connected.

The exemplary image distortion compensating unit may be constructed so as to only compensate for the distortion of the fingerprint rolled impression to approximate the fingerprint rolled impression to the fingerprint flat impression. In this case the image data of poorer quality is modified and caused to be approximated to the image data of better quality, so the accuracy of the synthesized image is improved.

The exemplary fingerprint image synthesizing device further includes skeleton data extracting unit for extracting skeleton data from the fingerprint rolled impression and fingerprint flat impression, and skeleton data matching unit for comparing the skeleton data of the fingerprint rolled impression and fingerprint flat impression extracted by the skeleton-data extracting unit with each other to generate pairing point data indicative of a correlation between these skeleton data. The image distortion compensating unit may compensate for distortion of at least one of the fingerprint rolled impression and the fingerprint flat impression, using the pairing point data generated by the skeleton data matching unit. Skeletons are thin lines obtained from ridges and other streaked pattern of fingers. Since the skeleton data are good in accurately representing the ridge data, the quality of the synthesized fingerprint image using the skeleton data is also improved in accuracy.

The exemplary image synthesizing unit may select the fingerprint flat impression in a portion in which the fingerprint rolled impression and fingerprint flat impression overlap each other and select an image of the fingerprint rolled impression or the fingerprint flat impression in a portion other than the overlapping portion in such a manner that the area of the synthesized fingerprint image reaches a maximum. In this case, a synthesized fingerprint image with good quality is obtained because the image of better quality, that is fingerprint flat impression, is used in the overlapping portion of both image data.

The exemplary fingerprint image synthesizing device may further include skeleton-overlapping portion evaluating unit for evaluating whether portions, where the skeleton of the fingerprint flat impression and the fingerprint rolled impression practically overlap, exist in succession at each of right and left peripheral portions of the fingerprint flat impression. In this case, the accuracy and utility value of the synthesized fingerprint image can be judged.

The exemplary fingerprint image synthesizing device may further include operator intervening unit for inputting operator's instructions. The image distortion compensating unit or the image synthesizing unit may have a function operated in accordance with the instructions issued from the operator intervening unit. Other units may also have a similar function respectively.

An exemplary fingerprint image synthesizing method according to the present invention comprises steps with each of which the respective unit of the fingerprint image synthesizing device according to the present invention are substituted. A fingerprint image synthesizing program according to the present invention causes a computer to execute the respective step of the fingerprint image synthesizing method according to the present invention.

Further, the present invention can also be expressed as follows:

(1) In the fingerprint image synthesizing device, a rolled impression of a finger and a flat impression of the same finger are used to compensate for distortion of one of the images, then portions from one image and other portions from the other image are thereafter selected in accordance with a fixed rule, and those selected two images are pasted (e.g. combined), thereby synthesizing the rolled impression and the flat impression.

(2) In above (1), the impression to be compensated for distortion is the rolled impression, and the flat impression is combined therewith without the compensation for distortion to thereby enhance the quality of a synthesized fingerprint image.

(3) In above (1), a large number of skeleton-overlapping points on skeletons can be used as pairing point data by utilizing skeleton data comparing functions in combination, thereby improving the accuracy of the synthesized fingerprint image.

(4) In above (2), detects the skeleton-overlapping portions (refer to the two portions surrounded by solid lines in FIG. 9.), in the right and left boundaries of the overlapping portions where the flat impression and the rolled impression overlap each other (The two portions will hereinafter be called “peripheral portions”) and selects the flat impression for the inner side between those two peripheral portions for synthesizing. Incidentally, the fingertip side of a fingerprint is upward and the palm side thereof is downward, and the direction orthogonal to the upward and downward directions shows the right and left.

(5) In above (1), the fingerprint image synthesizing device has the function allowing an operator to determine whether the result of an automatic synthesis is good, and manually designating a selected portion.

In other words, the present invention relates to a system for computer-processing a fingerprint image, wherein a flat impression and a rolled impression are combined to increase the area of the fingerprint image for better matching. In particular, it is possible to synthesize from the flat impression and the rolled impression a natural image in which a ridge flows smoothly, owing to the provision of the unit for comparing the skeleton data and the unit for compensating for the distortion of the image. The increased area of the synthesized image contributes to an improvement in accuracy. An improvement in the accuracy of a latent matching can be expected by increasing the comparing area for matching.

According to an exemplary aspect of the present invention, the area of a fingerprint image can be increased by an image synthesis using both of a fingerprint rolled impression and a fingerprint flat impression of the same finger, thus making it possible to improve the accuracy of matching. Particularly when an image-synthesized fingerprint is intended for matching of a small latent, its possibility of successful matching is higher than a case in which only the fingerprint rolled impression or the fingerprint flat impression is used. That is, by utilizing both of the rolled impression and the flat impression, a high-accuracy matching can be achieved.

According to the present invention, the accuracy of compensation for image distortion can be also improved by the use of skeleton data matching. As a result, the quality of a synthesized fingerprint image can also be enhanced and hence the accuracy of matching can be improved too.

Further, according to an exemplary aspect of the present invention, a rolled impression is distortion-compensated and a flat impression with better quality is left intact without any effect of modification in image synthesis. Thus the quality of the synthesized fingerprint image can be improved and hence the accuracy of matching can also be improved.

Furthermore, according to the present invention, it has the exemplary function allowing operators to determine whether the result of an automatically processed image synthesis is good, and manually designating a selected portion. Thus, since the quality of a synthesized fingerprint image can be enhanced, the accuracy of matching can also be improved.

### BRIEF DESCRIPTION OF THE DRAWINGS

While the specification concludes with claims particularly pointing out and distinctly claiming the subject matter which is regarded as the invention, it is believed that the invention, the aspects and features of the invention and further aspects, features and advantages thereof will be better understood from the following description taken in connection with the accompanying drawings in which:

FIG. 1 is a function block diagram showing a first exemplary embodiment of a fingerprint image synthesizing device according to the present invention;

FIG. 2 is a flowchart illustrating the operation of the fingerprint image synthesizing device shown in FIG. 1;

FIG. 3 is a diagram depicting an example illustrative of ten finger-fingerprint cards;

FIG. 4 is a diagram showing an example of a rolled impression;

FIG. 5 is a diagram showing an example of a flat impression;

FIG. 6 is a diagram illustrating an example of a rolled impression (gray image) subsequent to its distortion compensation;

FIG. 7 is a diagram depicting an example of a rolled impression (skeleton image) subsequent to its distortion compensation;

FIG. 8 is a diagram showing an example of superimposition of skeleton data on a fingerprint image;

FIG. 9 is a diagram depicting skeleton-overlapping-portions in the peripheral portions;

FIG. 10(A)-10(C) are a diagram showing models of a rolled impression and a flat impression employed in the present invention;

FIG. 11 is a diagram illustrating an example of a synthesized image;

FIG. 12 is a function block diagram showing a second exemplary embodiment of a fingerprint image synthesizing device according to the present invention; and

FIG. 13(D)-13(F) are a diagram depicting models of a rolled impression and a flat impression employed in a conventional technique.

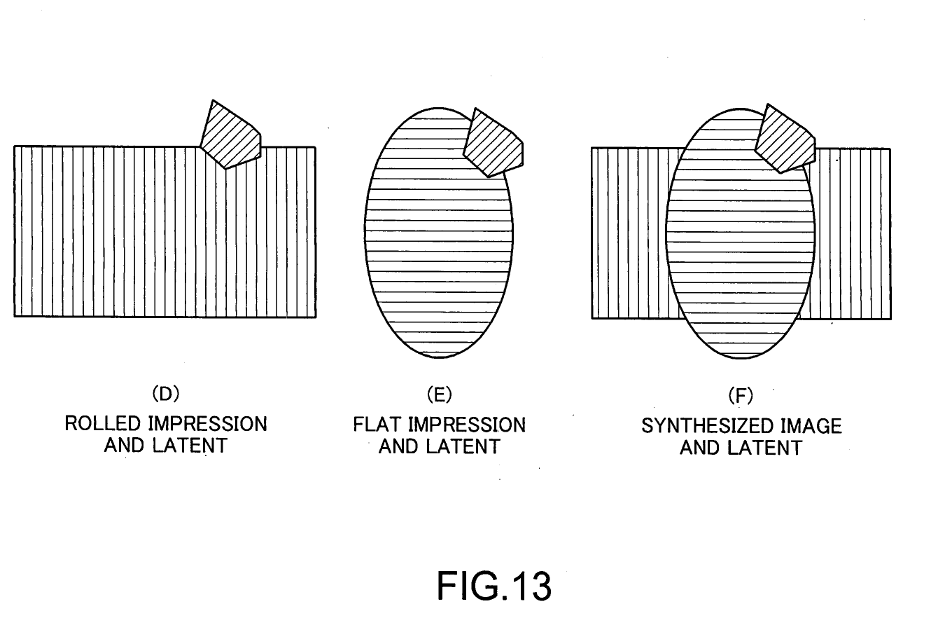

### DETAILED DESCRIPTION OF THE EXEMPLARY EMBODIMENTS

Exemplary embodiments of the present invention will hereinafter be described in detail with reference to the accompanying drawings.

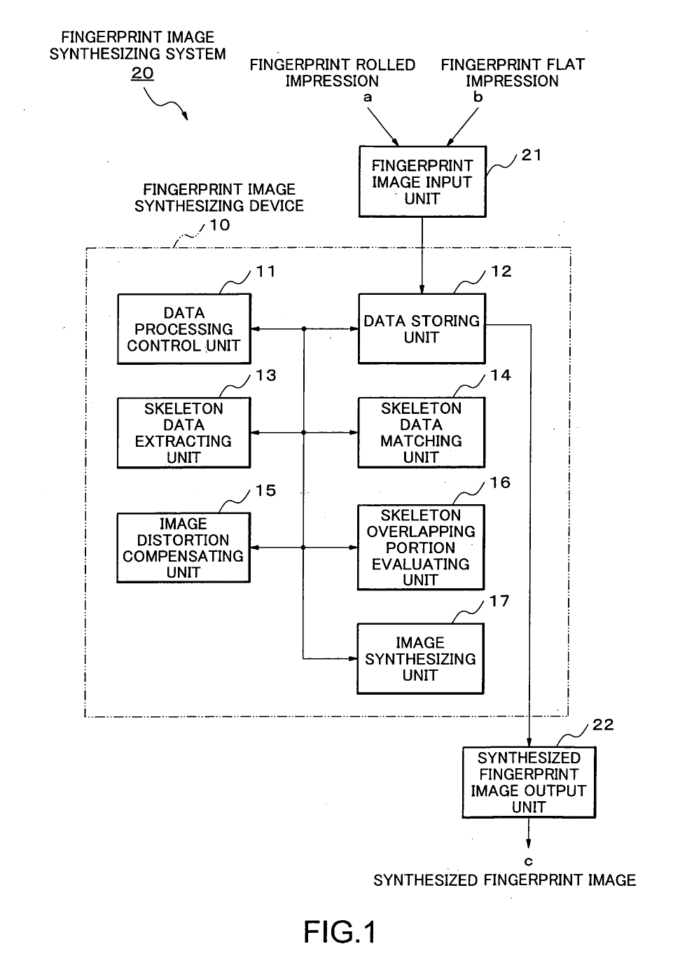

FIG. 1 is a function block diagram showing a first exemplary embodiment of a fingerprint image synthesizing device according to the present invention. The present embodiment will be described below based on the accompanying drawings.

The exemplary fingerprint image synthesizing device 10 according to the present invention basically includes an image distortion compensating unit 15 which compensates for distortion of at least one of a fingerprint rolled impression and a fingerprint flat impression to thereby approximate the fingerprint rolled impression and the fingerprint flat impression with each other, and an image synthesizing unit 17 which selects the fingerprint rolled impression and the fingerprint flat impression approximated by the image distortion compensating unit 15 to generate one synthesized fingerprint image. Also the fingerprint image synthesizing device 10 may be further equipped with other unit, added selectively, which will be described later and constitutes a fingerprint image synthesizing system 20 together with a fingerprint image input unit 21 and a synthesized fingerprint image output unit 22. They will be described in further detail rephrasing the fingerprint rolled impression and fingerprint flat impression as a fingerprint rolled impression a and a fingerprint flat impression b.

Each of the fingerprint rolled impression a and the fingerprint flat impression b is a digitized file of a fingerprint image of the same finger already read by a fingerprint sensor or a scanner. They are the images used for an image synthesis or composition.

While the fingerprint image input unit 21 is a device which digitizes the fingerprint image read by the fingerprint sensor or scanner and inputs it therein, it is also capable of inputting already digitized fingerprint image files therein.

The fingerprint image synthesizing device 10 includes a data processing control unit 11, a data storing unit 12, a skeleton data extracting unit 13, a skeleton data matching unit 14, an image distortion compensating unit 15, a skeleton-overlapping portion evaluating unit 16, an image synthesizing unit 17, etc. and has an interface between the fingerprint image input unit 21 and the; synthesized fingerprint image output unit 22.

The synthesized fingerprint image output unit 22 is a device such as a printer, a display or the like which outputs a synthesized fingerprint image (synthesized fingerprint image c).

The data processing control unit 11 is a unit which controls all elements or components of the fingerprint image synthesizing device 10 and controls an interface.

The data storing unit 12 is a unit which temporarily stores the fingerprint rolled impression a, the fingerprint flat impression b, skeleton data (including minutia data) of both the fingerprint rolled impression a and the fingerprint flat impression b, data indicative of a correlation between both skeleton data (this data may include a paired minutia list and a skeleton-overlapping points list, and are called pairing point data subsequently), etc.

The skeleton data extracting unit 13 is a unit which extracts features necessary for matching, such as the skeleton data, from the fingerprint image.

The skeleton data matching unit 14 is a unit which matches the skeleton data of the fingerprint rolled impression and the skeleton data of the fingerprint flat impression and generates pairing point data between these two fingerprint images.

The image distortion compensating unit 15 is a unit which compensates for distortion of the images and skeleton data of both fingerprint rolled impression and fingerprint flat impression, using the pairing point data given thereto.

The skeleton-overlapping portion evaluating unit 16 is a unit which evaluates a skeleton-overlapping portion where two skeletons overlap in peripheral portions, and evaluates whether the skeleton-overlapping portion exists continuously.

The image synthesizing unit 17 is a unit which determines image portions to be selected in accordance with the set rule from the flat impression and the rolled impression and synthesizes the selected portions to generate one synthesized fingerprint image.

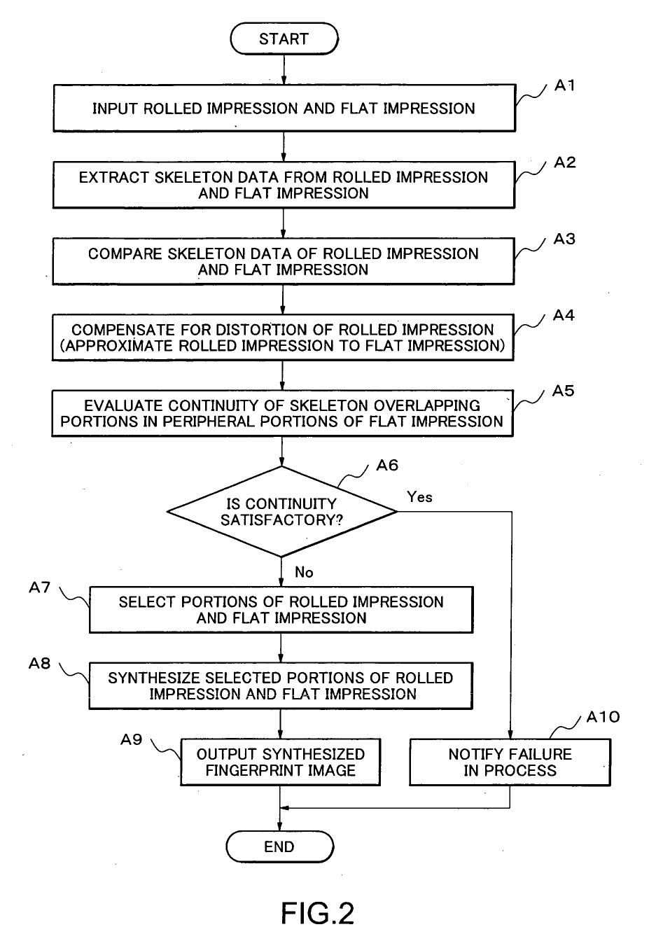

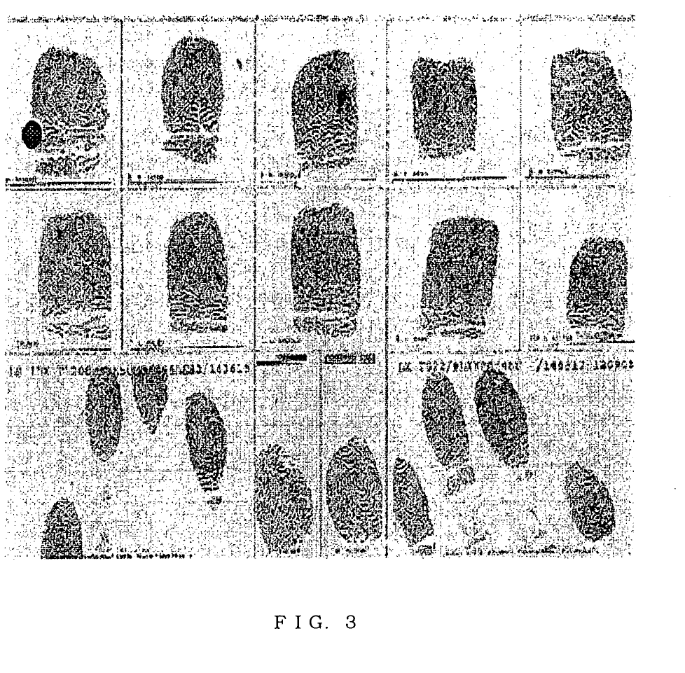

FIG. 2 is a flowchart showing the operation of the fingerprint image synthesizing device shown in FIG. 1. The operation of the present embodiment will be explained in detail with reference to FIGS. 1 and 2 and related drawings of FIGS. 3 through 11.

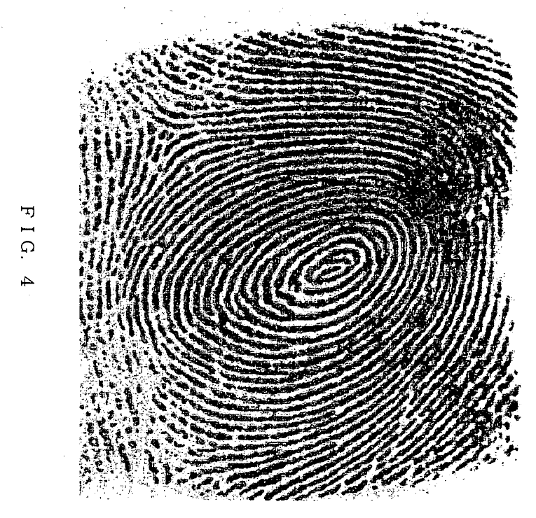

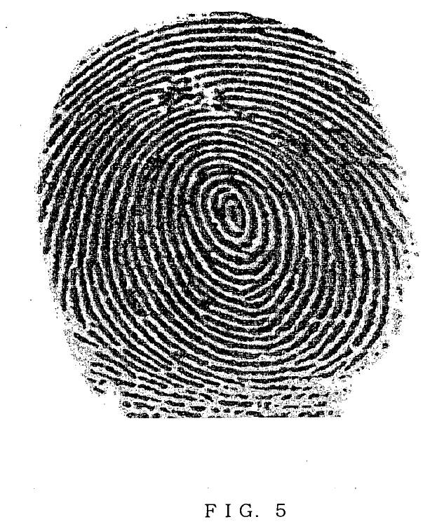

First, each of the fingerprint rolled impression a and the fingerprint flat impression b shown in FIG. 1 is digitized data file of the fingerprint image already read by the fingerprint sensor or scanner. FIG. 3 shows a scanned image example of ten finger-fingerprint cards, and FIGS. 4 and 5 respectively show image examples of a rolled impression and a flat impression in the fingerprint cards.

The term “rolled impression” corresponds to a fingerprint rolled and inked such that the lateral portions of each finger can also be fingerprinted or taken. In FIG. 3, the fingerprints are inked within 10 frames as viewed on the upper side of FIG. 3. The term “flat impression” corresponds to a fingerprint inked without being rolled. In FIG. 3, the fingerprints are inked in the undermost section thereof. These are digitized in a resolution of. 500 dpi in accordance with ANSI/NIST-CSL-1-1993 Data Format for the Interchange of Fingerprint, Facial & SMT Information standardized by U.S. National Institute of Standards and Technology.

In Step A1 of FIG. 2, fingerprint images of a rolled impression and a flat impression of the same finger are inputted by the fingerprint image input unit 21, which in turn are transmitted to the fingerprint image synthesizing device 10. These received two fingerprint images are temporarily stored in the data storing unit 12 by the data processing control unit 11.

In Step A2 of FIG. 2, the data processing control unit 11 takes out or fetches the fingerprint image from the data storing unit 12 and transmits it to the skeleton data extracting unit 13. The skeleton data extracting unit 13 binarizes or digitizes the received fingerprint image and thereafter effects thinning-line processing on it to extract skeleton data.

Subsequently, the skeleton data extracting unit 13 extracts fingerprint minutiae such as an end point and a bifurcation from the skeleton data. In the present specification, minutia data are expressed as parts of the skeleton data. This is because the minutia data is contained in the skeleton data. The minutiae set forth here mean an end of a skeleton and a skeleton's bifurcated point and such minutiae can be easily extracted from the skeleton data. The extracted skeleton data is temporarily stored in the data storing unit 12 by the data processing control unit 11.

The above-described digitizing process, thinning-line process and minutia extracting process can be implemented using, such known arts as described in, for example, Japanese Patent Publication No. Sho 60(1985)-12674 “Pattern feature extracting device” (Koh Asai) and its corresponding U.S. Pat. No. 4,310,827, “Device for extracting a density as one of pattern features for each feature point of a streaked pattern (Asai)”, incorporated herein by reference.

In Step A3 of FIG. 2, the data processing control unit 11 takes out the skeleton data from the data storing unit 12 and transmits it to the skeleton data matching unit 14. The skeleton data matching unit 14 executes a skeleton data comparing process between the received two skeleton data (rolled impression and flat impression). As a result of matching of the skeleton data, pairing point data indicative of a correlation between skeleton points on the two skeleton data is outputted. The result of matching of the pairing point data or the like is temporarily stored in the data storing unit 12 via the data processing control unit 11. The matching of the skeleton data can be implemented by using such a known art as described in, for example, the aforementioned patent document 1.

In Step A4 of FIG. 2, the data processing control unit 11 fetches out the image data and the pairing point data or the like from the data storing unit 12 and transmits the same to the image distortion compensating unit 15. The image distortion compensating unit 15 compensates for image distortion using the pairing point data. One example of an image distortion compensating method executed in this Step has been described in the aforementioned patent document 2. The post-distortion-compensated image and skeleton data thereof are temporarily stored in the data storing unit 12 through the data processing control unit 11. In the distortion compensating process, such alignment is also carried out concurrently so that the post-distortion-compensated image (for example, the image of the rolled impression) can be superimposed on another image (for example, the flat impression). Therefore, respective coordinate points of the post-distortion-compensated image correspond to the same coordinate points of another image.

Incidentally, fingerprint images, regardless of being flat impression or rolled impression, generally include image distortion and it is improper to say that image distortion occurs only on the one fingerprint image and no distortion occurs on another image. In the present embodiment, however, image distortion compensation process is applied only to one fingerprint image (for, example rolled impression) assuming that no distortion occurs in another fingerprint image (for example, flat impression). In other words, image deformation is effected on one image in such a manner that this one fingerprint image is approximated to another fingerprint image and a superimposed display can be made to another fingerprint image. In the present embodiment, the rolled impression is deformed to be approximated to and coincide with the flat impression.

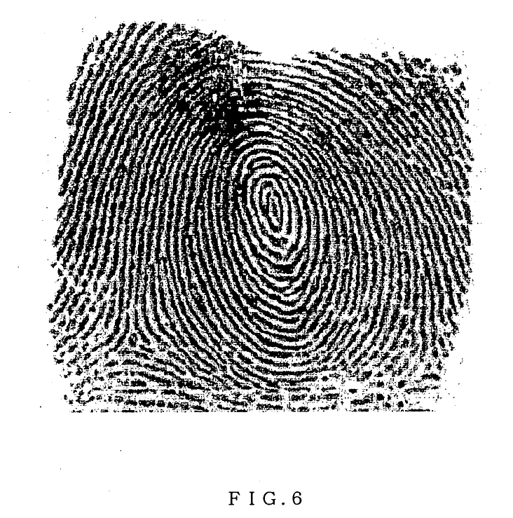

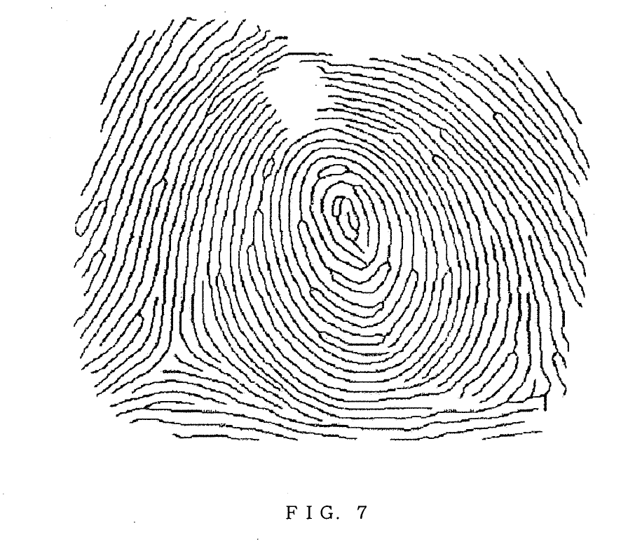

Since many pairing point data found as a result of the skeleton matching can be utilized, the accuracy of compensation for distortion is improved. FIG. 6 shows an example of a rolled impression whose image distortion is compensated by the above process, and FIG. 7 shows skeleton data thereof.

In Step A5 of FIG. 2, the data processing control unit 11 fetches the image data and skeleton data from the data storing unit 12 and transmits the same to the skeleton-overlapping portion evaluating unit 16. The skeleton-overlapping, portion evaluating unit 16 first divides an overlapping portion of the rolled impression and flat impression into small portion units and subsequently determines whether two skeletons coincide with each other in each small portion unit. A portion where the skeletons substantially coincide with each other is called a skeleton-overlapping portion, whereas a portion where they do not coincide is called a non-skeleton-overlapping portion.

Subsequently, the skeleton-overlapping portion evaluating unit 16 examines right and left peripheral portions of the flat impression and evaluates whether the skeleton-overlapping portion exists continuously. Data about each skeleton-overlapping portion is temporarily stored in the data storing unit 12 through the data processing control unit 11.

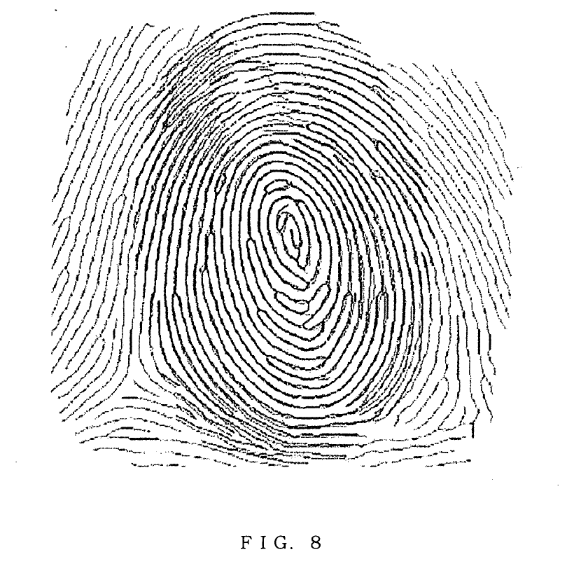

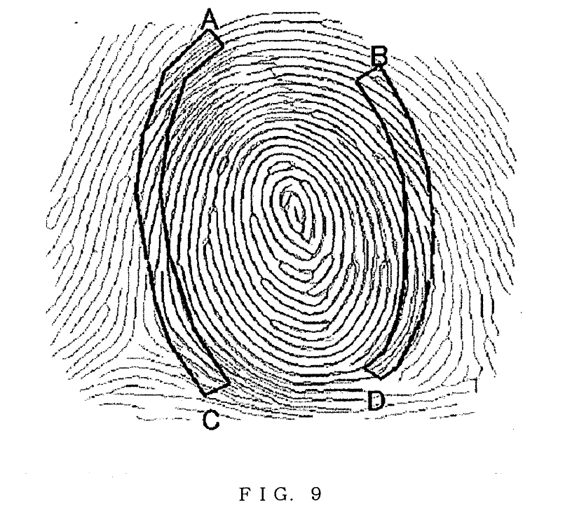

FIG. 8 shows skeleton data of a post-distortion-compensated (therefore approximated to the flat impression) rolled impression superimposed on skeleton of a flat impression. The skeleton of the rolled impression is lightly displayed in broken lines, and the skeleton of the flat impression is displayed in solid lines. FIG. 9 shows right and left peripheral portions of the flat impression, which are indicated by thick solid lines on the superimposed skeleton shown in FIG. 8.

The skeleton-overlapping portion evaluating unit 16 determines whether each small portion unit, in each of the two peripheral portions surrounded by the thick solid lines, is practically a skeleton-overlapping portion (e.g. predetermined number of skeletons or predetermined ratio of skeletons of the flat impression and the rolled impression overlaps with each other).

Subsequently, in Step A6 of FIG. 2, it is determined whether the peripheral portions are continuously judged as the practically-skeleton-overlapping portions. When it is determined so, the fingerprint image synthesizing device proceeds to Step A7. If not so, then the fingerprint image synthesizing device proceeds to Step A10.

In Step A7 of FIG. 2, the data processing control unit 11 fetches the image data and skeleton data and the data regarding the each skeleton-overlapping portion from the data storing unit 12 and transmits them to the image-synthesizing unit 17.

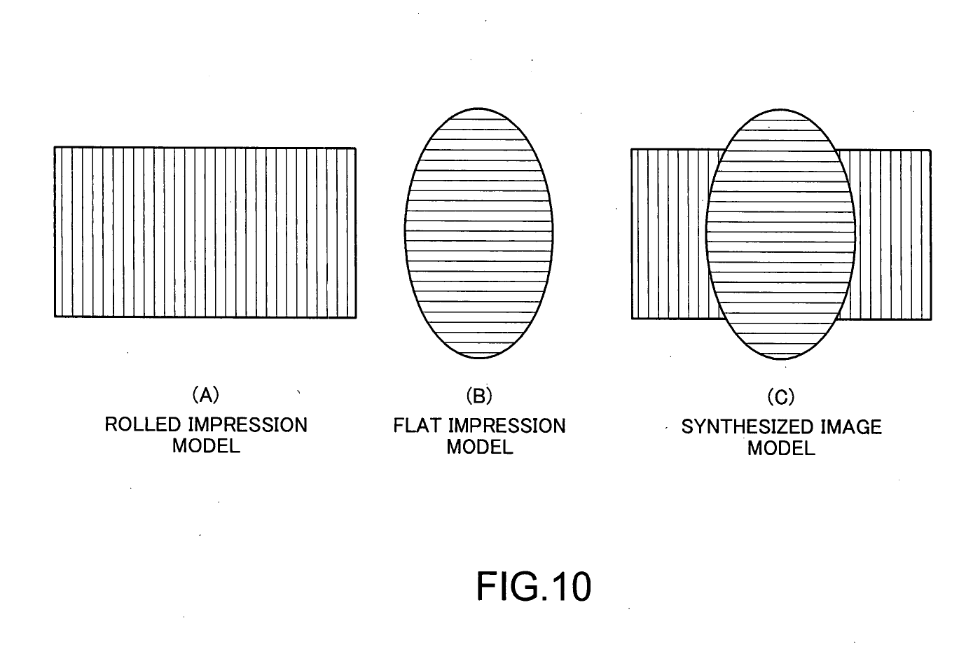

The image synthesizing unit 17 synthesizes the images of the flat and rolled impressions. A method for synthesizing the images will be explained using FIGS. 10(A), 10(B) and 10(C). FIG. 10(A) shows a typical inked form of a rolled impression, which is modeled in the form of a transversely long rectangle. FIG. 10(B) shows a typical inked form of a flat impression, which is modeled in the form of a longitudinally long ellipsoid. When these two fingerprint images are combined into one, it is rational to select the flat impression, which is better in quality, for an overlapped portion shaped in the form of a wide longitudinally long ellipsoid and select the remaining portions from the rolled impression. A model combined by this method is shown in FIG. 10(C).

The portion selecting method executed by the image synthesizing unit 17 will be explained step by step. Incidentally, a Y coordinate indicates a vertical direction as viewed in the figure. An upper point has a higher Y coordinate.

1) A point at which the Y coordinate reaches a maximum in a skeleton-overlapping portion on the left side peripheral portion is defined as A, as exemplarily showed in FIG. 9, and a point at which the Y coordinate reaches a minimum, is defined as C, as exemplarily showed in FIG. 9, respectively.

2) A point at which the Y coordinate reaches a maximum in a skeleton-overlapping portion on the right side peripheral portion is defined as B, and a point at which the Y coordinate reaches a minimum, is defined as D, respectively.

3) A portion surrounded by the skeleton-overlapping portions of the peripheral portion on the left side, the skeleton-overlapping portions of the peripheral portion on the right side, a straight line AB and a straight line CD is determined. The fingerprint flat impression is selected in a portion lying thereinside.

4) As to a portion located above the straight line AB, the areas inked between the flat impression and the rolled impression are compared and the larger one thereof is adopted. The flat impression is expected to be normally adopted.

5) As to a portion below the straight line CD in the flat impression, the areas inked between the flat impression and the rolled impression are compared and the larger one thereof is adopted.

6) As to the remaining portions, the rolled impression is expected to be selected because only the rolled impression is normally inked outside the skeleton-overlapping portions in the right and left peripheral portion.

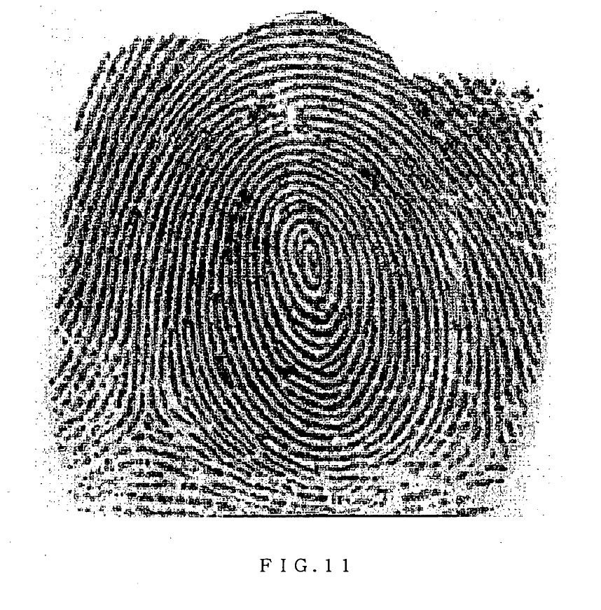

Subsequently, the image synthesizing unit 17 combines the selected images to create one new synthesized fingerprint image as indicated in Step A8 of FIG. 2. The synthesized image is temporarily stored in the data storing unit 12 through the data processing control unit 11. The fingerprint image synthesized in this way is illustrated in FIG. 11.

In Step A9 of FIG. 2, the, data processing control unit 11 fetches the synthesized image from the data storing unit 12 and transmits it to the synthesized fingerprint image output unit 22. The synthesized fingerprint image output unit 22 outputs the synthesized image to a subsequent function, thereby leading to completion of a series of processes.

In Step A10 of FIG. 2, the data processing control unit 11 transmits a notice of a failure in image synthesis to the synthesized fingerprint image output unit 22. The synthesized fingerprint image output unit 22 outputs the notice of its failure to the subsequent function, thereby leading to completion of the series of processes.

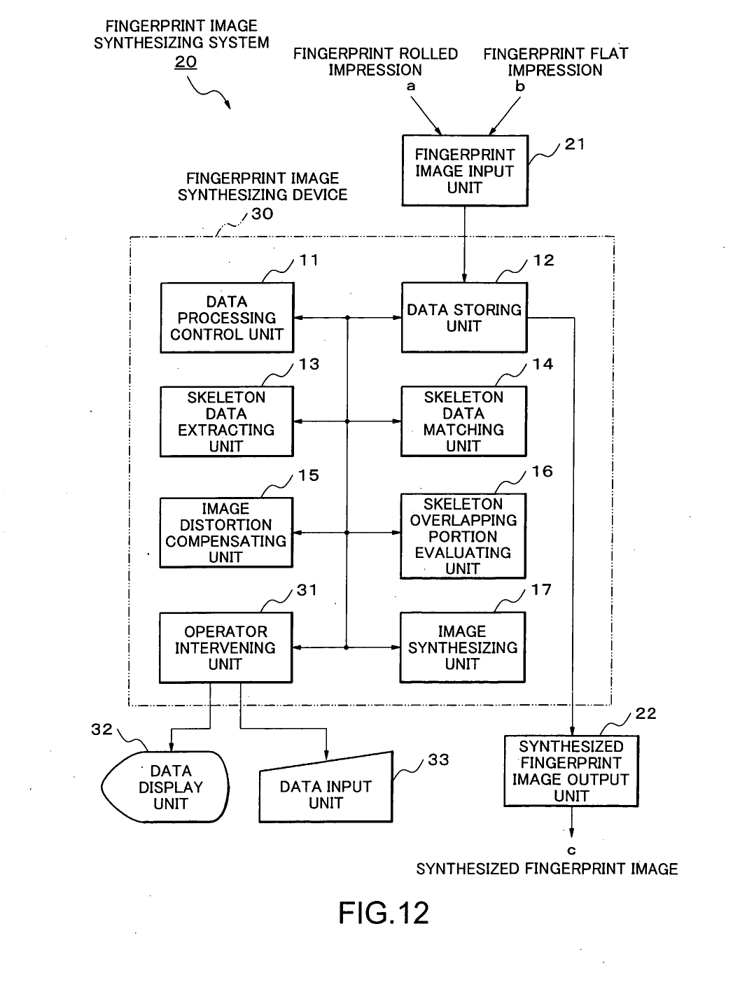

FIG. 12 is a function block diagram showing a second exemplary embodiment of a fingerprint image synthesizing device according to the present invention. The present exemplary embodiment will be explained below based on the figure. However, the same elements as those shown in FIG. 1 are given like reference numerals and the description thereof will therefore be omitted.

The fingerprint image synthesizing device 30 according to the present embodiment is further equipped with an operator intervening unit 31 which inputs operator's instructions allowing an operator to determine whether the result of an automatic synthesis is good, and manually designating a selected portion. Respective unit of the fingerprint image synthesizing device 30 have functions operated in accordance with instructions issued from the operator intervening unit 31. A data display unit 32 and a data input unit 33, which perform the input/output of data to and from the operator intervening unit 31, are connected to the fingerprint image synthesizing device 30.

The data display unit 32 is a display device or the like which displays a fingerprint image and skeleton data thereon.

The data input unit 33 is a pointing device such as a mouse, a tablet or the like, which inputs portion-selection information and manual instructions.

In the present exemplary embodiment, when the continuity of the skeleton-overlapping portions is determined in Step A6 of FIG. 2, the automatically determined result is displayed on the data display unit 32 to allow an operator to intervene in the result thereof. When it is desired to change the result, the operator is able to change it via the data input unit 33. That is, for example, the operator can change the judgments of the system on whether certain portions being skeleton-overlapping or not.

When the respective selected portions of the rolled fingerprint and flat fingerprint are determined in Step A7 of FIG. 2, the automatically calculated portions are displayed on the data display unit 33 to allow the operator to intervene in the result thereof. When it is desired to change the portions, the operator is able to change the same (e.g. selection between the rolled impressions and flat impressions for certain portions) via the data input unit 33.

When the images for the rolled impression and flat impression are synthesized in Step A8 of FIG. 2, the automatically processed synthesized image is displayed on the data display unit 32 to urge the operator to intervene in the result thereof. When it is desired to change the synthesized image, the operator is able to change it via the data input unit 33. That is, for example, the operator can define (select) new area of flat impression (or rolled impression) to be superimposed onto rolled impressions (or flat impression).

Incidentally, the present invention is not limited to the synthesizing of the images from the fingerprint rolled impression and the fingerprint flat impression. If there are two streaked images, like a fingerprint, palm print and footprint, and they are taken from the same finger, the same palm print portion or the same footprint portion, using any impression techniques which can be same or different, then the present invention can be applied to the synthesis of these two images. The present invention can be applied even when at least one of the two images may be distorted.

While the present invention has been described with reference to the illustrative embodiments, this description is not intended to be construed in a limiting sense. Various modifications of the illustrative embodiments, as well as other embodiments of the invention, will be apparent to those skilled in the art on reference to this description. It is therefore contemplated that the appended claims will cover any such modifications or embodiments as fall within the true scope of the invention.

Further, it is the inventor's intent to retain all equivalents in the claimed invention even if the claims are amended later during prosecution.

What is claimed is:

1. A print image synthesizing device comprising:
image distortion compensating unit that compensates for distortion of at least one of a first print impression, of an object and a second print impression of the same object to thereby approximate said first print impression and said second print impression to each other; and
an image synthesizing unit that selects portions of the first print impression and the second print impression approximated by said image distortion compensating unit, to generate one synthesized print image of said object.

2. The fingerprint image synthesizing device according to claim 1, wherein said first impression is a fingerprint rolled impression, said second impression is a fingerprint flat impression and said object is a finger.

3. The fingerprint image synthesizing device according to claim 2, wherein said image synthesizing unit selects said fingerprint flat impression in an overlapping portion of said finger where said fingerprint rolled impression and said fingerprint flat impression overlap each other, and
selects said fingerprint rolled impression or said fingerprint flat impression in portions other than said overlapping portion to maximize an area of the synthesized fingerprint image.

4. The fingerprint image synthesizing device according to claim 3, wherein said image distortion compensating unit compensates only for the distortion of the fingerprint rolled impression.

5. The fingerprint image synthesizing device according to claim 3, further comprising:
a skeleton data extracting unit that extracts first skeleton data from said fingerprint rolled impression and second skeleton data from said fingerprint flat impression; and
a skeleton data matching unit that compares the first skeleton data and the second skeleton data with each other and generates pairing point data indicative of a correlation between the first and the second skeleton data,
wherein said image distortion compensating unit compensates for the distortion of at least one of the fingerprint rolled impression and the fingerprint flat impression, using said pairing point data.

6. The fingerprint image synthesizing device according to claim 5, further comprising:
a skeleton-overlapping evaluating unit that determines whether skeleton-overlapping portions exist in succession in peripheral portions of each side of the fingerprint flat impression, where the first skeleton and the second skeleton overlap.

7. The fingerprint image synthesizing device according to claim 3, wherein said image synthesizing unit determines said overlapping portion based on one or plural peripheral portions of the fingerprint flat impression.

8. The fingerprint image synthesizing device according to claim 7, wherein said image synthesizing unit determines, as said overlapping portion, a portion surrounded by a straight line formed by connecting points at which a Y coordinate of two peripheral portions of each side of the fingerprint flat impression respectively reach a maximum, a straight line formed by connecting points at which the Y coordinate of said two peripheral portions reach a minimum, and said two peripheral portions.

9. The fingerprint image synthesizing device according to claim 3, further comprising:
an operator intervening unit that inputs an operator's instructions,
wherein said image distortion compensating unit or said image synthesizing unit has a function operated in accordance with the instructions issued from said operator intervening unit.

10. A print image synthesizing device comprising:
image distortion compensating means for compensating for distortion of at least one of a first print impression of an object and a second print impression of the same object to thereby approximate said first print impression and said second print impression to each other; and
an image synthesizing means for selecting portions of the first print impression and the second print impression approximated by said image distortion compensating unit, to generate one synthesized print image of said object.

11. The fingerprint image synthesizing device according to claim 10, wherein said first impression is a fingerprint rolled impression, said second impression is a fingerprint flat impression and said object is a finger.

12. A fingerprint image synthesizing method comprising:
compensating for distortion of at least one of a first print impression of an object and a second print impression of the same object to thereby approximate said first print impression and said second print impression to each other; and
selecting portions of the first print impression and the second print impression approximated by said image distortion compensating unit, to generate one synthesized print image of said object.

13. The fingerprint image synthesizing method according to claim 12, wherein said first impression is a fingerprint rolled impression, said second impression is a fingerprint flat impression and said object is a finger.

14. The fingerprint image synthesizing method according to claim 13, wherein selecting said fingerprint flat impression in an overlapping portion of said finger where said fingerprint rolled impression and said fingerprint flat impression overlap each other, and selecting said fingerprint rolled impression or said fingerprint flat impression in portions other than said overlapping portion to maximize an area of the synthesized fingerprint image.

15. A fingerprint image synthesizing method comprising:
an image distortion compensating step for compensating for distortion of at least one of a first print impression of an object and a second print impression of the same object to thereby approximate said first print impression and said second print impression to each other; and
an image synthesizing step for selecting portions of the first print impression and the second print impression approximated by said image distortion compensating unit, to generate one synthesized print image of said object.

16. The fingerprint image synthesizing method according to claim 15, wherein said first impression is a fingerprint rolled impression, said second impression is a fingerprint flat impression and said object is a finger.

17. A signal-bearing medium tangibly embodying a program of machine-readable instructions executable by a digital processing apparatus to perform
an image distortion compensating process for compensating for distortion of at least one of a first print impression of an object and a second print impression of the same object to thereby approximate said first print impression and said second print impression to each other; and
an image synthesizing step for selecting portions of the first print impression and the second print impression approximated by said image distortion compensating unit, to generate one synthesized print image of said object.

18. The signal-bearing medium according to claim 17, wherein said first impression is a fingerprint rolled impression, said second impression is a fingerprint flat impression and said object is a finger.

19. The signal-bearing medium according to claim 18, wherein said image synthesizing process selects said fingerprint flat impression in an overlapping portion of the said finger where said fingerprint rolled impression and said fingerprint flat impression overlap each other, and
selects said fingerprint rolled impression or said fingerprint flat impression in portions other than said overlapping portion to maximize the area of the synthesized fingerprint image.
